(19) United States
(12) Patent Application Publication
(10) Pub. No.: US 2002/0149557 A1
(43) Pub. Date: Oct. 17, 2002

(54) Digital light valve addressing methods and apparatus and light valves incorporating same

(75) Inventors: Howard V. Goetz, Tigard, OR (US); Steven H. Linn, Hillsboro, OR (US); David L. Keith, Vancouver, WA (US)

Correspondence Address: One World Trade Center, Suite 1600, 121 S.W. Salmon Street, Portland, OR, 97204, US

(73) Assignee: Sarif, Inc.

(21) Appl. No.: 10/032,283

(22) Filed: Dec. 20, 2001

Related U.S. Application Data
(60) Provisional application No. 60/258,265, filed on Dec. 20, 2000.

(51) Int. Cl. G09G 3/36

(52) U.S. Cl. 345/100

(57) ABSTRACT

Display systems include display drivers that receive digital video data and retain digital pixel values corresponding to a row of pixels of a display panel. The retained digital pixel values are digitally compared with a digital count produced by a digital counter and at a transition time determined by the comparison of the digital pixel value and the digital count, a data ramp signal is applied to the pixel. The data ramp signal is configured to be time varying so that the transition time at which the data ramp signal is applied to the pixel can be used to establish a pixel voltage corresponding to a desired image value. In an example, digital pixel values corresponding to a first row of pixels are processed so that the data ramp signal is applied to each pixel of the first row at transition times determined by the digital image values associated with each pixel. While the digital image values of the first row of pixels are processed, digital pixel values corresponding to a second row of pixels are received and stored for processing after processing of the first row is complete.

### RELATED APPLICATIONS

This application claims the benefit of U.S. Provisional Application No. 60/258,265, filed Dec. 20, 2000 which is incorporated herein by reference.

### FIELD OF THE INVENTION

The invention pertains to methods and apparatus for addressing displays such as liquid crystal display panels and display systems that include such methods and apparatus.

### BACKGROUND

Projection displays based on liquid crystal layers formed on a polysilicon substrate permit display pixels to be addressed using active circuitry defined on the polysilicon substrate. In contrast, displays based on liquid crystal layers formed on passive substrates must provide external circuitry to address pixels, typically with increased circuit costs and complexity. In addition, interconnection of external circuitry to display panels is difficult and expensive.

One prior art display addresses pixels by applying pixel voltages produced by external driver circuitry while providing pixel multiplexers on the display to connect incoming data to successive columns of pixels. For displays having large numbers of pixels, addressing each pixel with an appropriate signal voltage may be difficult, especially if images are to be updated rapidly enough to display motion. Typical refresh rates or frames rates are between 60 Hz and 70 Hz. For a 60 Hz frame rate, a time period of about 16.7 msec is available for writing a frame. For a display that has 600 rows of 800 pixels per row, a total time of about 16.7/600 msec or about 28 μsec is available to write a row. Several pixels (typically 6) in a row are simultaneously written, so that about 200 ns are available to write each pixel. are available per row. Unfortunately, such long times are unavailable for some high resolution displays and provide no margin of error for other displays. For example, for a display panel having column capacitances of about 33 pF and column resistances of about 500 Ohms, the corresponding RC time constant is about 16 ns. If the signal voltage at a pixel is to closely approximate the applied signal voltage, as many as 5 RC time constants are required to establish the desired pixel voltage. Thus, a time period of about 80 ns is needed to address one pixel in a column. Typically an additional 50-75 nsec are needed for multiplexer switching, setup and hold times, and settling times. Thus, at least about 150 ns must be available for addressing pixels. For a 600 by 800 pixel display, this much time is available but with little or no margin of error and for higher resolution displays, less that 150 ns is available. While more than 6 pixels per row can be written simultaneously, smaller and more complex FETs are required that have larger on resistances, increasing the pixel writing times. Thus, increasing the number of simultaneously written pixels generally does not permit addressing of high resolution displays.

In addition to these shortcomings, prior art display systems are generally configured to display and process analog video data. If such systems are to be used with digital video data, a digital-to-analog conversion is performed. Such conversion not only requires additional circuitry that increases system cost, but also introduces errors in the image signal caused by any imperfections of the conversion process.

In view of these and other shortcomings of the prior art, improved displays, display drivers, and methods for controlling display panels are needed, particularly systems and methods configured for digital video data.

### SUMMARY OF THE INVENTION

Display systems are provided that include a display panel that defines an array of pixels having rows and columns. A row memory is configured to receive digital pixel values corresponding to pixels of a selected row of the display panel. A digital comparator module is provided that includes digital comparators corresponding to the pixels of the selected row. The digital comparators include comparator inputs that are situated and configured to receive corresponding digital pixel values from the row memory and comparator outputs that are in communication with corresponding columns of the display panel. In some embodiments, a level shifter or other buffer is provided that receives the comparator outputs and delivers processed comparator outputs to the display columns. A digital counter is situated and configured to provide a digital ramp count to the digital comparator module, so that the digital comparators provide comparator outputs based on a comparison of a corresponding digital pixel value. In representative embodiments, the display systems also include a display controller that receives a digital video signal and provides the digital pixel values to the row memory.

According to alternative embodiments, display systems include a row input module configured to receive digital pixel values corresponding to an additional row of the display panel while digital pixel values corresponding to a previously selected row are delivered to the comparator module. The display controller is configured to direct the digital pixel values of corresponding to the additional row to the comparators upon completion of processing of the digital pixel values of the previously selected row by the comparators. According to representative embodiments, the row input module includes a shift register module. In other representative embodiments, the row input module includes a bi-directional shift register module configured to process 8-bit digital pixel values for the pixels. In specific examples, the bidirectional shift register modules include two digital inputs/outputs that can be configured to serve as inputs or outputs based on a signal applied to a shift direction input. The shift register modules include digital pixel value outputs for delivering digital pixel values to the digital comparators. According to additional embodiments, the row input module includes a parallel latch configured to retain digital pixel values for processing by the comparators.

In further embodiments, display systems include a flip-flop module configured to receive the comparator outputs and deliver column control voltages to the display panel. According to alternative embodiments, a display controller is configured to initiate or terminate counting by the digital counter and to direct the parallel latch or other row input module to store received digital pixel values, or to permit acquisition of additional pixel data.

Display drivers are provided that include a shift register module configured to receive digital pixel values corresponding to a row of pixels or a portion of a row of pixels. A latch is configured to receive the digital pixel values from shift registers of the shift register module and to store the digital image values under control of a control voltage applied to a latch input. A digital counter is configured to provide a digital ramp to a plurality of digital comparators that include comparator inputs configured to receive the digital ramp and a respective digital pixel value from the latch. The comparators also include comparator outputs that provide output voltages based on a difference between (or other comparison of) the digital pixel values and the digital ramp. According to representative embodiments, the digital pixel values include at least 2 data bits. In other examples, the digital pixel values include at least 8, 10, or 12, or more data bits. In still further embodiments, the digital ramp includes at least 8, 10, 12, or more bits. According to alternative embodiments, the display driver includes a level shifter configured to adjust the comparator outputs for delivery to the display panel.

Methods of delivering digital pixel values to a row of pixels in a display panel that includes pixels arranged in rows and columns are provided. The methods include receiving digital pixel values corresponding to a plurality of pixels in a first row of pixels. A digital ramp count is initiated and the digital pixel values are compared with the digital ramp count. A data ramp signal is delivered to each of the pixels at a time corresponding to a transition time determined by a comparison of the digital pixel values and the digital ramp count. According to additional methods, digital pixel values corresponding to an additional row of pixels are received while digital pixel values corresponding to a first row of pixels are compared with the digital ramp count.

In representative embodiments, the digital pixel values include at least 2 data bits, 4 data bits, or 8 data bits. In further embodiments, the digital ramp count includes as many as about 8 bits.

Display panel drivers are provided that include a data store for retaining digital pixel values corresponding to a row of pixels. A counter is configured to provide a digital count signal. Digital comparators corresponding to respective pixels of the row of pixels are provided. The digital comparators are configured to receive the digital count signal and the digital pixel value associated with each of the pixels, and to provide an output comparison signal that changes from a first level to a second level at a transition time determined by the comparison. Voltages applied to the pixels are determined by the corresponding transition times, and in representative embodiments, time-varying data ramp signal is applied to the pixels at times associated with the data dependent transition times.

Circuits for supplying digital pixel values to a plurality of pixels in a row of a display are provided. The circuits include a digital counter that produces a digital count and plurality of comparators corresponding to each of the plurality of pixels. The comparators are configured to receive the digital count and a corresponding digital pixel value, and produce respective outputs based on a comparison of the digital count and the digital pixel value. In additional embodiments, the circuits include a latch module that receives the digital pixel values and delivers the digital pixel values to corresponding comparators.

These and other features and advantages of the invention are set forth below with reference to the accompanying drawings.

### BRIEF DESCRIPTION OF THE DRAWINGS

FIG. 1 is a schematic block diagram of a display system that includes a sample and hold module that includes sample and hold capacitors corresponding to two rows of pixels.

FIG. 2A is a schematic block diagram of a display system that includes digital pixel drivers that receive a digital video signal and deliver digital image values to a display panel that includes an array of pixels.

FIG. 2B is a schematic block diagram of a representative pixel of the display panel of FIG. 2A.

FIG. 3 is a schematic diagram of a digital pixel driver shown in FIG. 2A.

FIG. 4 is a schematic block diagram of a display system that includes even and odd column display drivers.

### DETAILED DESCRIPTION

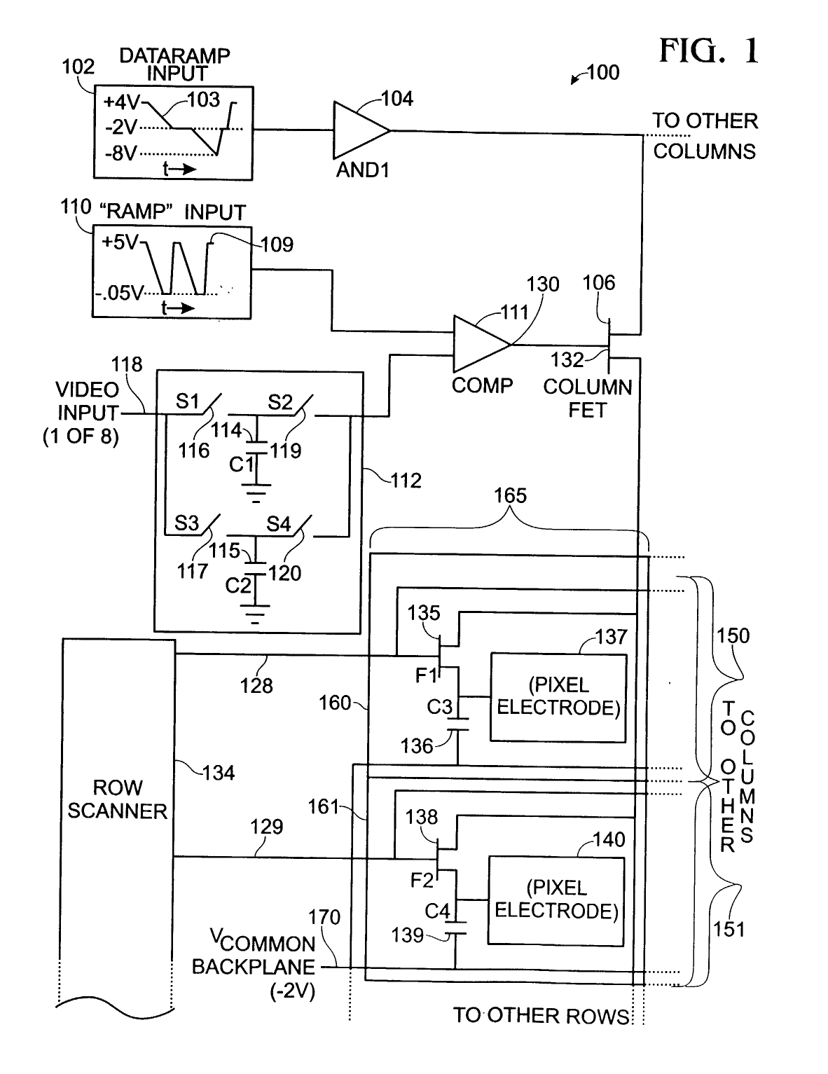

With reference to FIG. 1, a display system 100 includes pixels arranged in one or more rows and one or more columns. FIG. 1 shows only a column 165 and rows 150, 151 that include representative pixels 160, 161, and other pixels, and rows and columns of pixels are not shown. A typical display system includes 200-2000 rows and 200-2000 columns of pixels. The pixels 160, 161 include FETs 135, 138, pixel capacitors 136, 139, and pixel electrodes 137, 140, respectively. The pixel electrodes 137, 140 are situated to provide image dependent pixel voltages to a liquid crystal or other display element with respect to a voltage applied to a backplane electrode 170 that is common to some or all pixels.

A DATARAMP source 102 supplies a DATARAMP voltage, such as a time-dependent voltage 103 to a buffer 104. The buffered DATARAMP voltage is then delivered to a series of column FETs, such as the exemplary column FET 106. The display system 100 typically includes additional column FETs corresponding to each column of pixels. A RAMP source 110 provides a RAMP voltage, such as a time-dependent voltage 109, to a comparator 111 that also receives voltages corresponding to image picture elements (pixels) from a sample and hold (S/H) module 112. The S/H module 112 includes sample capacitors 114, 115 that receive image voltages from a video input 118 from a video source or other image source (not shown in FIG. 1) via sample input switches 116, 117. The module 112 also includes sample output switches 119, 120 corresponding to sample capacitors 114, 115. The switches 116, 117, 119, 120 are generally configured so that one of the capacitors 114, 115 charges to a sample voltage corresponding to a pixel voltage via the corresponding switch 116, 117, respectively, while a pixel voltage stored on the other of the capacitors 114, 115 is delivered to the comparator 111 via the corresponding switch 119, 120. As a specific example, the switch 116 is closed to permit the capacitor 114 to charge and the switch 120 is closed to permit the voltage on the capacitor 115 to be delivered to the comparator 111. The switches 117, 119 are open. After charging the capacitor 114 and delivery of the voltage on the capacitor 115 to the comparator 111 is complete, the switch states are reversed so that the capacitor 115 charges to a pixel voltage corresponding to another pixel and the sample voltage on the capacitor 114 is delivered to the comparator 111. The module 112 includes the sample capacitors 114, 115 that acquire and store pixel voltages for pixels in a single column and additional modules can be provided for the remaining columns. In a representative example, the display columns are divided into eight groups and eight video inputs (such as the video input 118) are sequentially switched to sample and hold modules associated with the columns. For example, a first video input is sequentially switched to sample and hold modules for columns 1, 9, 17, . . . , a second video input is sequentially switched to sample and hold modules for columns 2, 10, 18, . . . , and other video inputs are similarly switched. For convenience, only one sample and hold module is shown in FIG. 1.

The delivery of data to the row 150 begins with the column FET 106 and a scanner output 128 configured so that a voltage on the pixel capacitor 136 follows the DATARAMP voltage. The sample capacitor 114 is charged to an voltage determined by a video signal applied to the video input 118. At a switching time T_{S}, the comparator is switched off in response to the RAMP voltage and the voltage on the sample capacitor 114. As a result, the column FET 106 is also turned off and a DATARAMP voltage associated with the switching time T_{S} remains on the pixel capacitor 136 and the voltage on the pixel capacitor 136 does not follow additional changes in the DATARAMP voltage. Pixels of other rows and columns are addressed in a similar fashion by controlling a switching time at which pixel capacitors stop following the DATARAMP voltage.

Comparison of a voltage on a capacitor (such as the capacitor 114) with the RAMP input 109 converts a pixel voltage from a video input voltage to a switching time T_{S} at the comparator 111. The switching time T_{S} controls the column FET 106 to select a voltage applied to a pixel by the DATARAMP input 103. This procedure can be regarded as conversion of a pixel voltage to a pixel dependent switching time that is then reconverted into a pixel voltage.

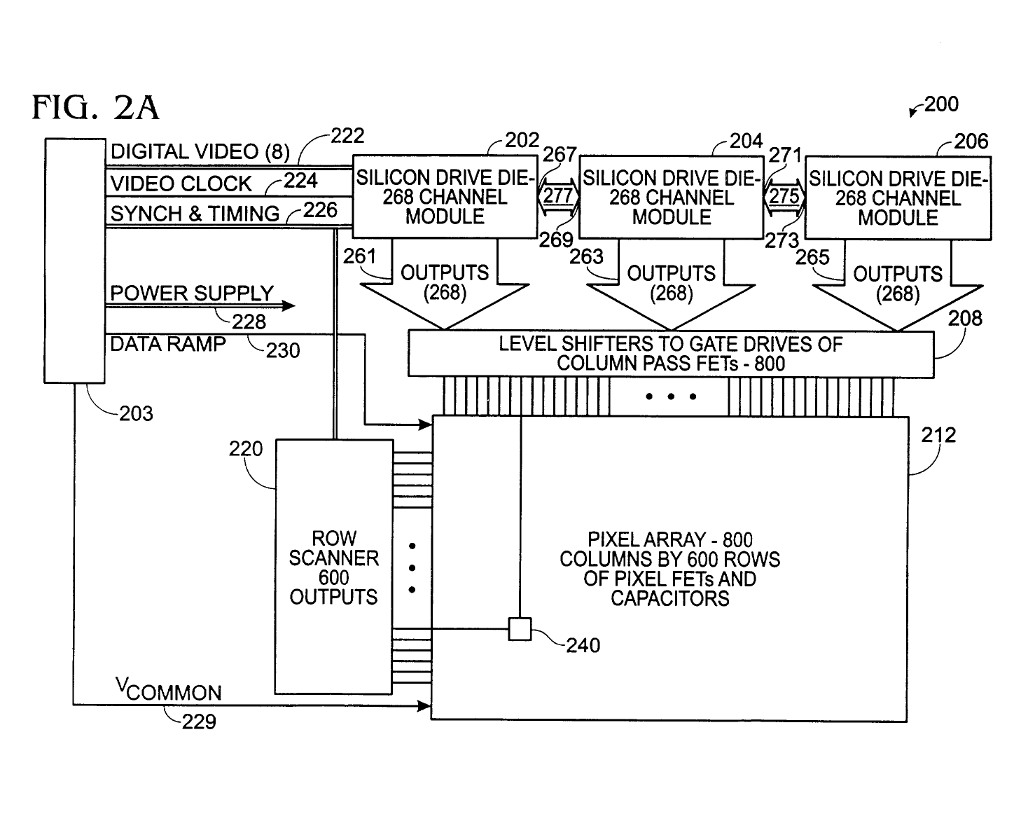

With reference to FIG. 2A, a display system 200 includes pixel drivers 202, 204, 206 that are in electrical communication with a set 208 of level shifters that connect to a display panel 212. The display system 200 includes a row scanner 220, one or more video inputs, such as a video input 222 that is configured to receive a digital video signal, a video clock input 224, a synchronization input 226, a power supply input 228, a backplane input 229 (for a voltage V_{common}), and a DATARAMP input 230 that are conveniently provided by a display controller 203. The display panel 212 includes an array of pixels that are arranged in rows and columns and that include respective pixel capacitors and pixel FETs similar to those illustrated in FIG. 1. With reference to FIG. 2B, a representative pixel 240 includes a pixel FET 242 having a gate 243 connected to a row select electrode 248 and a source (or drain) electrode 245 that is connected to a column electrode 250. The pixel FET 242 controls charging of a pixel capacitor 244 and thus the voltage applied by a pixel electrode 246 to a liquid crystal layer or other display element. In addition, the pixel 240 includes a backplane electrode 252 that can be maintained at a backplane voltage, typically about −2 V.

As shown in FIG. 2A, each of the pixel drivers 202, 204, 206 provides respective pixel outputs 261, 263, 265 for 268 columns of pixels. Other arrangements are possible for displays having few or more pixels, and the pixel drivers 202, 204, 206 need not provide the same numbers of pixel outputs. In addition, the pixel drivers 202, 204, 206 include digital video input/output (I/O) ports 267, 269, 271, 273 and are configured so that digital video data and control signals can be transmitted between the pixel drivers 202, 204, 206 over interconnect data buses 275, 277. Typically, a digital video signal provided to the digital video input 222 includes data for more column pixels than a number of columns addressable by any one of the pixel drivers 202, 204, 206 and digital video data is shifted from one pixel driver to another using the interconnect data buses 275, 277 so that an entire row of pixels data values can be acquired.

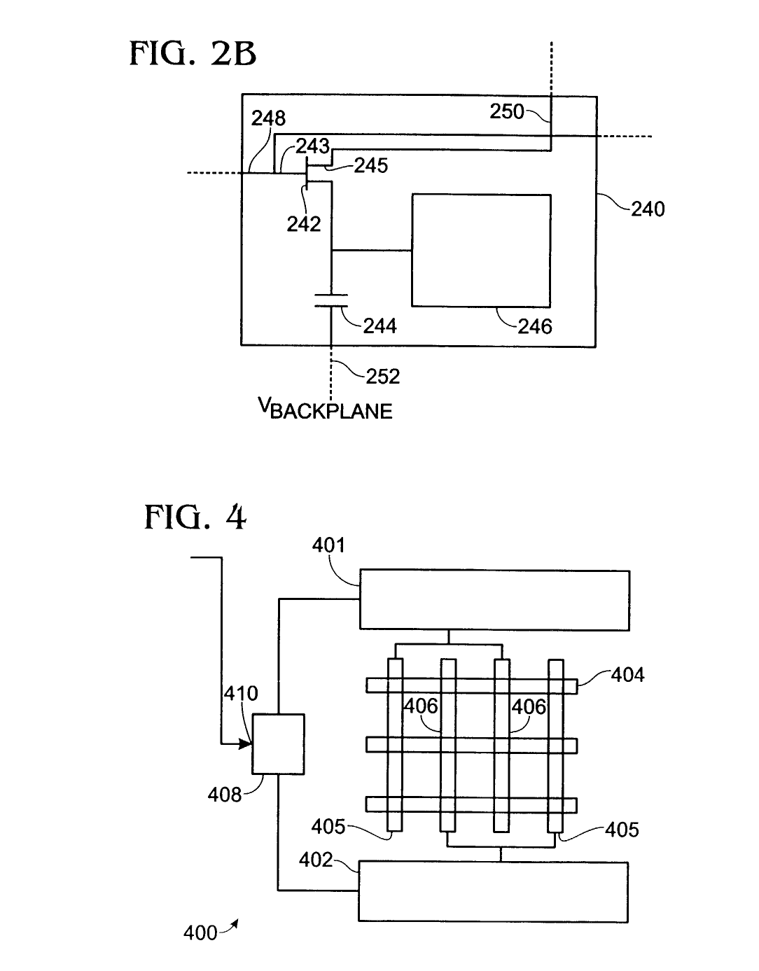

FIG. 3 is a schematic block diagram of the pixel driver 202. As noted above, the pixel drivers 204, 206 are generally similar but can be configured for different numbers of columns or pixels or be otherwise differently configured. Accordingly, the configuration of FIG. 3 is representative only and additional embodiments can be configured for alternative display panel configurations. As shown in FIG. 3, the pixel driver 202 includes a bidirectional shift register module 302, a parallel latch module 304, an 8-bit comparator module 306, and a set-reset (S-R) flip-flop module 308. In the example of FIG. 3, the pixel driver 202 is configured to supply pixel control voltages determined by 8-bit digital video data to pixels in as many as 268 columns. The shift register module 302 is 268 words long so that 268 8-bit digital data values can be shifted into the shift register module 302. In the configuration shown in FIG. 2, the digital video data includes 8-bit values for an entire row of pixels. For digital video corresponding to images defined by, for example, 800 columns of pixels, about 532 digital data values are shifted through the shift register module 302 for communication to the pixel drivers 204, 206 via the buses 275, 277.

The shift register module 302 includes a shift enable input 310, a clock input 311, and a shift direction input 312 that are in electrical communication with the display controller 203. A voltage applied to the shift enable input 310 by the display controller 203 directs the shift register module 302 to be responsive to video data received at a video input 313. If the shift register module 302 is enabled, the video data is shifted pixel by pixel at a rate determined by a video clock signal applied to the clock input 311 until 268 columns of pixel data are shifted. If additional video data is received, video data is shifted from the shift register 302 to the output 267 and the digital video bus 277 that typically connects to a corresponding input of a additional pixel drivers such as the pixel drivers 204, 206. Video data is shown shifted from left-to-right in FIG. 3, but video data can be shifted either from right-to-left or left-to-right depending on a shift direction voltage applied to the shift direction input 312. In additional embodiments, the shift register module 302 is configured as a unidirectional module so that digital video is shifted in a single direction.

The shift register module 302 includes data outputs 320 that communicate data to the parallel latch 304. In the example of FIG. 3, the parallel latch module 304 is configured to receive 268 data bytes that correspond to each of the data values retained in the shift register module 302. A latch control input 324 is provided that is configured to receive a latch control voltage from, for example, a display controller such as the display controller 203, and that determines if data bytes delivered to the parallel latch module 304 are stored. Latch outputs 331 are in communication with a B-input 333 of the comparator module 306.

The comparator module 306 includes 268 8-bit comparators that are configured to receive 8-bit data bytes from corresponding portions of the B-input 333. Each of the 8-bit comparators also includes an input that is configured to receive an 8-bit comparison voltage provided by an 8-bit digital ramp counter 335 to an A-input 336. Each of the 8-bit comparators includes a corresponding comparator output that is connected to a respective comparator module output 337.

The digital ramp counter 335 includes a count enable (CE) input 339, a clock input (CLK), and a clear input (CLR) 341 in addition to an 8-bit counter output 342 that is connected to the A-input 336. The flip-flop module 308 includes 268 S-R flip-flops that have corresponding set inputs 350, reset inputs 351 and outputs 353. The outputs 353 are connected to the level shifter 208 for delivery to gate inputs of respective column FETs similar to the column FET 106 shown in FIG. 1.

Referring further to FIGS. 2-3, the display system 200 operates as follows. The display controller 203 receives a digital video signal and derives video timing information from the digital video signal. The timing information associates particular digital video data values with corresponding pixels of the display panel 212. For example, data values can be assigned to appropriate rows and columns, and pixel values corresponding to pixels at a start and an end of a row can be determined. In addition, a clock signal is supplied corresponding to a rate at which pixel data values are transmitted in the digital video signal, and horizontal and vertical synchronization data can be determined.

At the beginning of a row, the controller 203 provides a set voltage to the flip-flops of the module 308. As a particular example, the S-R flip-flop 360 is enabled so that a voltage is applied to a gate of a column FET 362 so that a DATARAMP voltage applied to the column FET 362 is delivered to a column of pixels. The digital ramp counter 335 is cleared. At a time defined as an initial time, a ramp enable voltage is applied to a ramp enable input 364, and the digital ramp counter 335 begins to count. At a switching time T_{S} that is dependent on the digital pixel value applied to a B-input 366 of the comparator 368 and a digital ramp count applied to an A-input 370 of the comparator 368, the flip-flop 360 is reset so that the DATARAMP voltage is disconnected from the column of pixels. The digital pixel value is received from a shift register 372 and a latch 374. The DATARAMP voltage is similarly connected and disconnected to other columns of pixels, but for convenience the associated flip-flops, comparators, latches, shift registers, and the corresponding column FETs are not shown in FIG. 3. Configuration of the time-dependence of the DATARAMP voltage in conjunction with transition times T_{S} associated with the digital pixel values permits pixel dependent voltages to be applied to all pixels in a selected row while digital pixel values associated with additional rows are acquired.

Display controllers that include the pixel drivers 202, 204, 206, . . . , level shifters, video memory, or other circuitry can be conveniently defined on one or more semiconductor substrates using a process technology such as CMOS circuitry. Electrical communication with a display panel can be provided with, for example, a series of solder bumps that are used to attach display controller circuitry to a display panel.

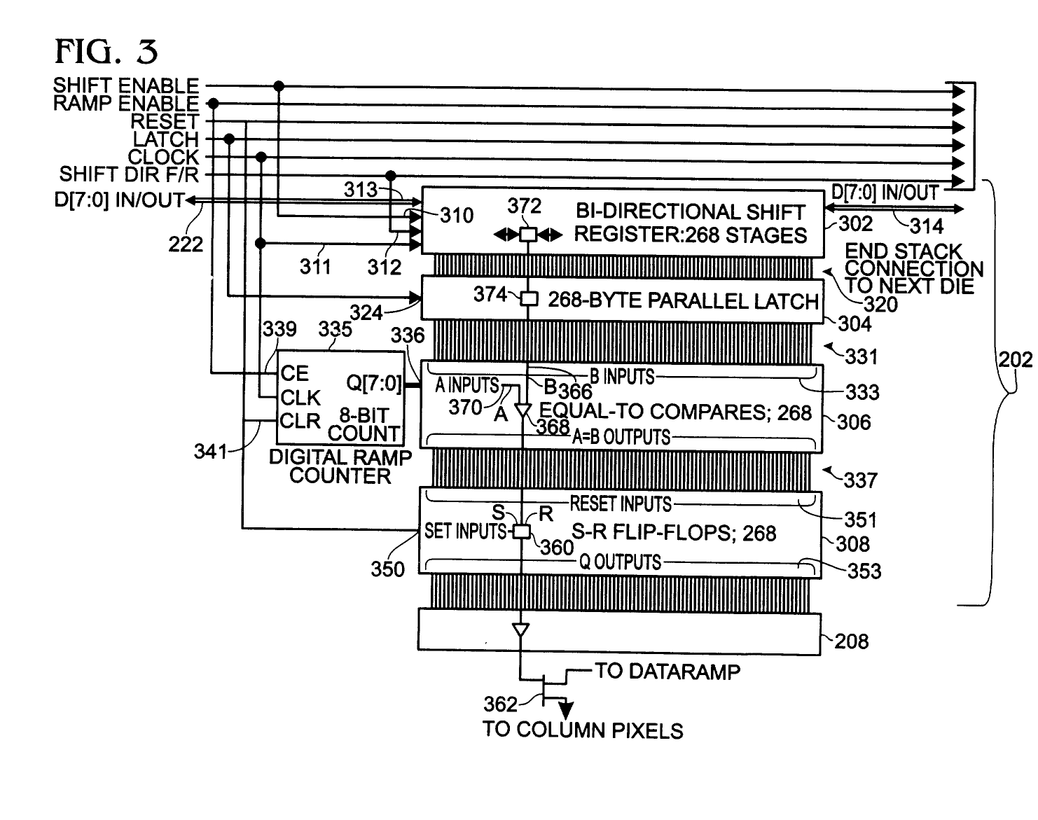

With reference to FIG. 4, a display system 400 includes pixel drivers 401, 402 configured to write image data to pixels in rows 404 and in odd columns 405 and even columns 406, respectively. A column selector 408 includes a video input 410 and is configured to deliver odd or even column data to the pixel drivers 401, 402, respectively.

The embodiments described above are examples only and it will be apparent to those skilled in the art that these embodiments can be modified in arrangement and detail without departing from the principles and scope of the invention. For example, various pixel driver functions can be provided with in a single integrated circuit or with a combination of integrated circuits. Circuit functions can be supplied with a combination of integrated circuits and discrete circuitry, and some embodiments include only one or more of the functions provided in the representative examples described above. Display systems, pixel drivers, and other components can be configured for various numbers of pixels, and display systems can include display devices other than TFT LCDs. In addition, dedicated circuitry can be provided for the display controller and/or pixel drivers, or software controllable components can be appropriately configured using a programming language. The operation of the example display systems and pixel drivers are described above with reference to various signals defined as voltages or time-varying voltages, but implementations based on currents or combinations of currents and voltages are possible. The digital ramp counter can be configured to count from a low value to a high value, a high value to a low value, or from an intermediate value back to an intermediate value. In other embodiments, pixel driver circuitry can be partially or completely defined on a common substrate with the display panel. In view of these and other variations, the invention is not to be limited by the particular embodiments described, and we claim all that is encompassed by the appended claims.

We claim:

1. A display system, comprising
a display panel defining an array of rows and columns of pixels
a comparator module that includes a plurality of comparators that include comparator inputs that are situated and configured to receive corresponding digital image values and comparator outputs that are in communication with corresponding columns of the display panel; and
a digital counter situated and configured to provide a digital ramp count to the comparator module, such that the comparators provide comparator outputs based on a comparison of a corresponding digital image value and the digital ramp count

2. The display system of claim 1, further comprising a row memory configured to receive the digital image values associated the selected row of pixels and to provide the digital image values associated with the selected row of pixels to the comparator module.

3. The display system of claim 2, further comprising a row memory configured to receive the digital image values associated with an unselected row of pixels and to provide the digital image values associated with the unselected row of pixels to the comparator module.

4. The display system of claim 1, further comprising a row memory configured to receive the digital image values associated with an unselected row of pixels and to provide the digital image values associated with the unselected row of pixels to the comparator module.

5. The display system of claim 4, further comprising a shift register configured to deliver digital image values to the comparator module.

6. The display system of claim 5, wherein the shift register includes a digital image input/output.

7. The display system of claim 5, wherein the shift register includes a shift direction input configured to determine a shift direction.

8. The display system of claim 5, wherein the row memory includes a parallel latch.

9. The display system of claim 1, further comprising a flip-flop module configured to receive the comparator outputs and deliver corresponding column control voltages to the display panel.

10. The display system of claim 1, further comprising a display controller configured to initiate or terminate counting by the digital counter.

11. A display driver, comprising:
a shift register configured to receive digital pixel values;
a latch configured to receive the digital pixel values from the shift register and to store the digital pixel values under control of a control voltage applied to a latch input;
a digital counter configured to provide a digital ramp;
digital comparators that include comparator inputs configured to receive the digital ramp and a respective digital pixel value from the latch and comparator outputs, wherein the digital comparators are configured to provide output voltages based on a difference between the digital pixel values and the digital ramp.

12. The display driver of claim 11, wherein the digital pixel values include at least 2 bits.

13. The display driver of claim 11, wherein the digital pixel values include at least 8 bits.

14. The display driver of claim 13, wherein the digital ramp includes at least 8 bits.

15. The display driver of claim 11, further comprising a plurality of flip-flops corresponding to the digital pixel values associated with the row of pixels and configured to receive respective comparator outputs and deliver processed comparator outputs to the row of pixels.

16. The display driver of claim 11, further comprising a level shifter configured to adjust the pixel outputs.

17. The display driver of claim 11, further comprising solder bumps configured to electrically connect the display driver to a display panel.

18. A method of delivering digital pixel values to a row of pixels in a display panel that includes pixels arranged in rows and columns, the method comprising:
receiving and storing digital pixel values corresponding to a first row of pixels;
initiating a digital ramp count;
digitally comparing a stored digital pixel value with the digital ramp count and delivering a data ramp signal to a pixel at a time based on the comparison.

19. The method of claim 18, further comprising receiving digital pixel values corresponding to a second row of pixels while comparing the stored digital pixel values with the digital ramp count.

20. The method of claim 18, wherein the digital pixel values include at least 4 data bits.

21. The method of claim 20, wherein the digital pixel values include at least 8 data bits.

22. The method of claim 18, wherein the comparison of the stored digital pixel value with the digital ramp signal defines transition times for the pixels, and voltages applied to the pixels are dependent on respective transition times.

23. A display panel driver, comprising:
a data store for digital pixel values corresponding to a row of pixels;
a counter that provides a digital count signal; and
digital comparators corresponding to respective pixels of the row of pixels, the digital comparators configured to receive the digital count signal and a respective digital pixel value, and to provide an output comparison signal that changes from a first level to a second level in response to a difference between the digital count signal and the digital pixel values.

24. A circuit for supplying digital pixel values to a plurality of pixels in a row of a display, the circuit comprising:
a digital counter that produces a digital count; and plurality of comparators corresponding to the plurality of pixels and configured to receive the digital count and corresponding digital pixel values, and produce respective outputs based on a comparison of the digital count and the digital pixel value.

25. The circuit of claim 24, further comprising a latch module that receives the digital pixel values and configured to deliver the digital pixel values to corresponding comparators.

26. A display controller, comprising:
a video selector configured to identify first and second video signal portions corresponding to a first set of display columns and a second set of display columns;
a first column driver configured to deliver the first video signal portion to the first set of display columns; and
a second column driver configured to deliver the second video signal portion to the second set of display columns.
